(19) United States
(12) Patent Application Publication
(10) Pub. No.: US 2008/0158230 A1
(43) Pub. Date: Jul. 3, 2008

(54) Automatic facial animation using an image of a user

(75) Inventors: Yogesh Sharma, San Francisco, CA (US); Sanjay Sharma, Mumbai (IN); Abhijeet Kini, Mumbai (IN); Arfat Allarakha, Mumbai (IN); Arthur Schram, San Francisco, CA (US); Dharmendra Sakpal, Mumbai (IN); Divesh Vijay Raut, Mumbai (IN); Inderjit Mand, Mumbai (IN); Kevin B. Arawattigi, Mumbai (IN); Prasad Abhyankar, Thane (IN); Riyaz Khan, Mumbai (IN); Shashank Sathe, Thane (IN)

Correspondence Address: Trellis Intellectual Property Law Group, PC, 1900 EMBARCADERO ROAD, SUITE 109, PALO ALTO, CA, 94303, US

(73) Assignee: Pictureal Corp., San Francisco, CA (US)

(21) Appl. No.: 11/648,258

(22) Filed: Dec. 29, 2006

(51) Int. Cl. G06T 13/00

(52) U.S. Cl. 345/473; 382/190

(57) ABSTRACT

In one embodiment, a method for facial animation is provided. The method first determines an image of a user. Facial feature information for a facial region is then detected in the image. For example, a number of points around the face for a user are determined. The facial region is then normalized based on the content and the facial feature information. The normalized facial region is then animated into a series of animated facial images. These series of animated facial images may be automatically inserted in the content. Accordingly, an image of a user's face may be automatically inserted into the content from the image of the user using the above method. The content may then be played where the animated series of facial images is included in the content being played.

### BACKGROUND

Embodiments of the present invention generally relate to automatic facial animation.

Facial recognition may be used to recognize a user's face in an image. Once the user's face is recognized, it may be animated. For example, a designer may animate the facial image using a manually-intensive process. For each expression that is desired, the designer determines how to manipulate pixels on the facial image to create the expressions. This is manually performed and eventually the series of expressions may be animated on the facial image. This is a labor intensive process and involves user intervention. Thus, a designer is always needed to animate the facial image. This does not allow a user's facial image to be used spontaneously as user intervention is always needed. This may limit the uses for facial recognition and facial animation.

### SUMMARY

In one embodiment, a method for facial animation is provided. The method first determines an image of a user. For example, the image may be a picture of a user or any human face. The picture of the user may be determined in many ways, such as by a user uploading a picture, by a scan of an image, through a search of web pages for images, sending through a mobile phone with a camera, networked cameras capturing images in any location, etc. Facial feature information for a facial region is then detected in the image. For example, a number of points around the face for a user are determined. The facial region is then normalized based on the content and the facial feature information. For example, different images may have a facial region that is oriented in different ways. This step normalizes the determined facial region into a standardized facial region that may be embedded into the content. The normalized facial region is then animated into a series of animated facial images. These series of animated facial images may be automatically inserted in the content. Accordingly, an image of a user's face may be automatically inserted into the content from the image of the user using the above method. The content may then be played where the animated series of facial images is included in the content being played.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts a simplified system for automatically performing facial animation according to one embodiment of the present invention.

FIG. 2 depicts a more detailed embodiment of an animator according to one embodiment of the present invention.

FIG. 3 depicts a simplified flow chart of a method for performing facial animation according to one embodiment of the present invention.

FIG. 4 depicts an example for determining an image according to one embodiment of the present invention.

FIG. 5 shows an example of an animated facial image that has been inserted in content according to one embodiment of the present invention.

FIG. 6 depicts a method of an example for an application provided on a web site according to one embodiment of the present invention.

FIG. 7 depicts a system for providing a personalized conversation according to one embodiment.

### DETAILED DESCRIPTION OF EMBODIMENTS

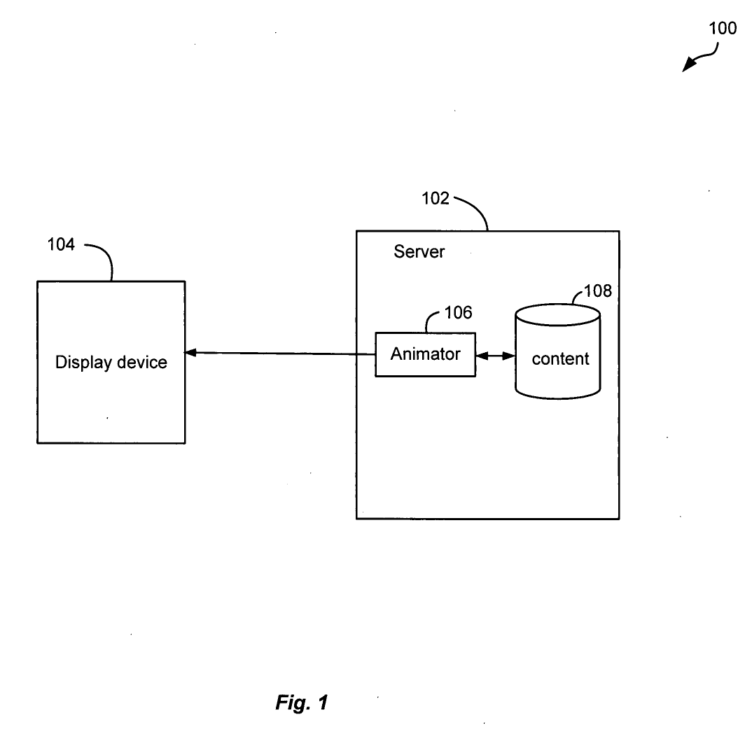

FIG. 1 depicts a simplified system 100 for automatically performing facial animation according to one embodiment of the present invention. As shown, a server 102 and display device 104 are provided. Server 102 includes an animator 106 and a content database 108.

Display device 104 may be any device in which content can be played with the facial animation. For example, display device 104 may be a personal computer, laptop computer, cellular phone, personal digital assistant (PDA), work station, voice over Internet protocol (VoIP) telephone, a billboard, advertisement space, computer in a store, etc. Display device 104 may be a device being used by a user, such as a user's cellular phone or computer. Also, display device 104 may be associated with an entity, such as a business operating a billboard, and is used by a user.

Server 102 may be any computing device configured to serve content to display device 104. For example, server 102 may include a web server, computer, etc.

Animator 106 is configured to automatically perform the facial animation. For example, an image of a user may be determined. The image may be determined from any sources. For example, the image may be uploaded, determined from a uniform resource locator (URL), received from a scan of a document, received through a search, received through a picture taken by a user using display device 104, etc. Other methods of determining an image of a user will be appreciated. For example, the image may be determined by receiving the image via an email, mobile phone, video, and any electronic device capable of taking a picture, locally or remotely.

The image may be determined from any medium. For example, the image may be determined from a static file, such as a digital picture, scan of a picture, document, etc. Also, the image may be determined in dynamic media. For example, a face may be detected in a video of a user. In one example, coordinates may be detected on the face in a frame of video as it is being played.

Animator 106 can take an image of the user's facial region and automatically animate it. For example, different expressions may be generated for the facial region. The different expressions may then be inserted in content stored in content database 108. Thus, the appropriate facial expressions are generated for the content and then inserted into the content in place of a facial region originally in the content. For example, the content may include a person. That person's face is replaced by the animation of the user's face. Accordingly, facial expressions are animated in the content such that it appears the user's face is actually in the content.

Server 102 may then serve the content to display device 104. Accordingly, the content may be viewed with the user's inserted facial image inserted in it. As the content plays, the user's facial image is shown with the various animated facial expressions.

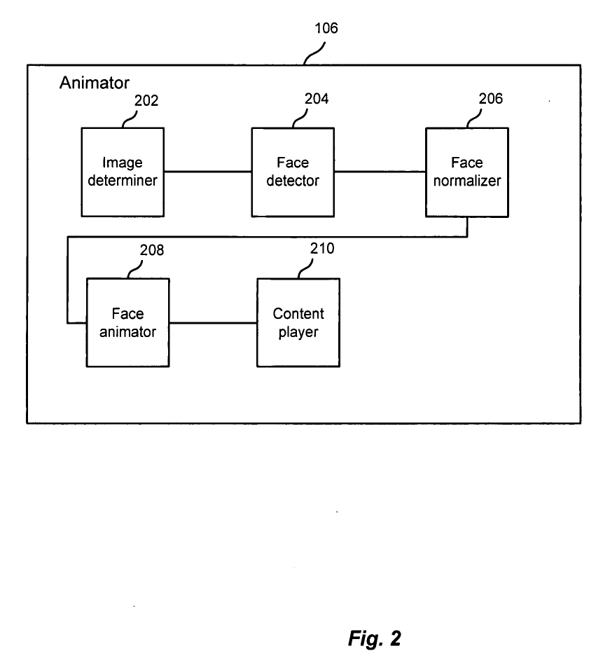

FIG. 2 depicts a more detailed embodiment of animator 106 according to one embodiment of the present invention. As shown, an image determiner 202, a face detector 204, a face normalizer 206, a face animator 208, and a content player 210 are provided. Image determiner 202 is configured to determine an image of a user. Although an image of a user is described, the image may be of any item. For example, the user may not be the person viewing the content that will be played but may be an image of another person, such as an image found in an advertisement, newscast, movie trailer, commercial, etc. Also, the user may be an image of an animal, an animated character, etc. Further, images of features other than a face may be used, such as images of other body parts, images of inanimate objects, etc. However, for discussion purposes, the term user will be used.

Image determiner 202 may determine the image in many ways. For example, a user may upload a photograph to image determiner 202. In another example, a uniform resource locator (URL) may be submitted. Image determiner 202 may then open the web page associated with the URL and determine an image in the web page. A scan of a photograph or any other document may also be used. Image determiner 202 may also perform a search to determine an image. For example, a search may be for the “President of the U.S”. Images of the President of the U.S. may then be determined for the search. These images may then be used. Further, a picture may be taken of a user, such as through a picture phone, digital camera, etc, and then uploaded. Other ways may also be appreciated. For example, a user may upload a video from any digital format and from the video, a particular scene may be used as an image.

Once the image is determined, face detector 204 is configured to determine a facial region in the image. In one embodiment, facial detector 204 determines facial feature information. The facial feature information defines the facial region, such as an outline of the facial region and the features of the face (eyes, ears, etc.). This may be a number of points that are arranged around features of the face. In one embodiment, 87 points are determined for features around the facial region of a user in the image. For example, the points may surround the eyes, ears, nose, mouth, and other parts of the face.

Once the information for the facial region is determined, face normalizer 206 is configured to standardize the facial region. It is expected that animator 106 may receive different kinds of images of users. Accordingly, the facial regions for these users may be different. For example, the angle that the faces are oriented in may be different, curves of the faces may be different, the shape of the faces may be different, etc. In one example, a first user's face may be an angled side view and a second user's face may be straight on. Face normalizer 206 is configured to standardize the images of these faces in a standard way such that they can be inserted into the content in a uniform manner.

In one embodiment, face normalizer 206 standardizes the facial region based on the facial feature information as determined by face detector 204. For example, the points determined for features of the facial region are used to normalize the facial region. Also, face normalizer 206 takes into account the content in normalizing the face. For example, the face may need to be different sizes, shapes, etc. based on where the face will be inserted in the content. Face normalizer 206 then normalizes the face based on the points determined and how it may be inserted into the content. For example, if the face is tilted, then it is straightened; if the face is looking to the right it can shift the perspective for it to be looking straight; and so on.

Normalizer 206 can also create a 3-D model of the face out of just one picture, which allows for its insertion in various 3-D environments such as video games. It programmatically deduces what the full head of the person might look like in a 3-D environment and renders the model.

Face animator 208 then is configured to animate the normalized facial region. In one embodiment, face animator 208 manipulates pixels on the normalized facial region to generate different expressions. A series of expressions may be generated for the content. These expressions may be the ones that may be used in the content. Also, more than the needed facial expressions may be generated. Then, the needed ones may be selected. This may be used when a template is used. A larger than needed number of expressions may be generated, and then the necessary expressions are selected.

In one embodiment, the facial animation is done automatically without user intervention. Although user intervention may be used. For example, a user may adjust the normalized facial region if desired. This adjustment may change the angle, rotation, size, etc. of the normalized facial region. However, the facial animation may still be automatically performed. In one embodiment, face animator 208 determines which pixels should be altered to create an expression from the facial image. For example, if a blinking eye is desired, face animator 208 may determine points that indicate where the eye is. Face animator 208 is then configured to alter pixels around those points to make the eye blink. For example, pixels around the open eye may be altered to make the eye appear to close. Face animator 208 performs this process for every expression that is needed for the content.

Face animator 209 may perform other tasks needed for animation. For example, various other special effects that are done on the face: color correction (automatic re-colorization of the face), treatments (make up, ageing—adding wrinkles or smoothening the skin to make it look younger and so on), effects (like making the face look animated, posterized, charcoal drawing, pencil drawing, watercolor effect and so on).

Content player 210 is then configured to generate content with the animated facial images. For example, content player 210 inserts the different facial expressions into the content at the appropriate places. In one example, the content may include a person (or any other character, object, etc.). The facial expressions are then inserted in place of the person's face in the content such that the appropriate expressions are played at the appropriate times. Thus, the content may be played with an image of the user's face. As the content is played, the facial expressions of the user's image are shown in place of the original person's face in the content.

The above process is performed by animator 106 without any user intervention. Once the image of the user is determined, the animation of the facial region and insertion into the content is automatic. This process may be performed for any image that includes a facial region. Accordingly, multiple images may be processed and inserted into content. This allows the dynamic insertion of user's faces into content.

In one example, an image of a user may be determined. For example, a user may upload an image to a website. The facial region of the user in the image is then determined. Embodiments of the present invention can then standardize the facial region and animate it with different facial expressions. Content is determined and the facial expressions are then embedded in the content at the appropriate place. For example, a person's face that was previously shown in the content may be replaced with the animated face of the user. The content may then be played. For example, the user may see an animated face of him/herself in the content being played in a website. This process may be performed automatically upon determining the image. For example, a user may upload a photo using the website and then automatically be provided with the content that includes an image of the user's face being animated. This is performed without any user intervention other than uploading the photo. Accordingly, the personalized content may be served to many users dynamically. This may be performed with different images of users' faces.

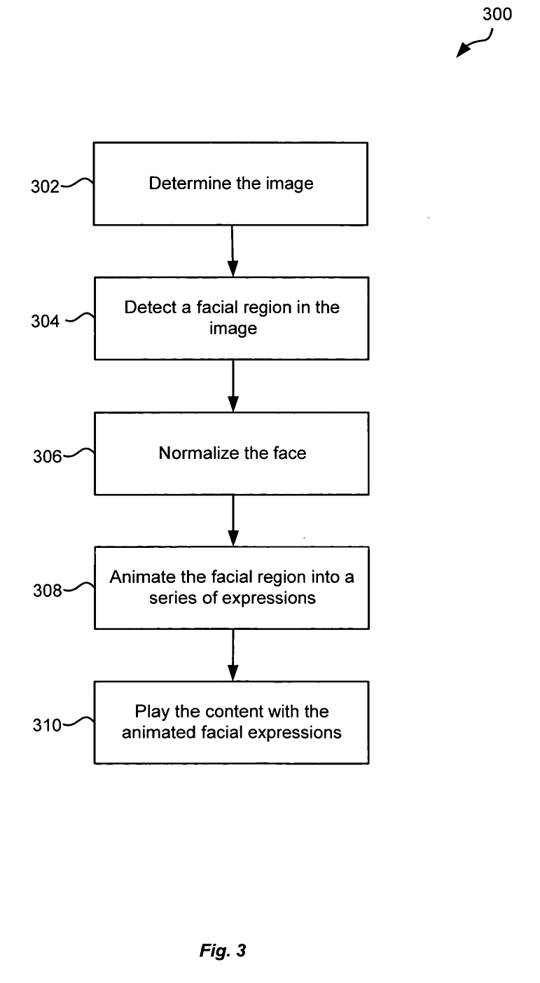

FIG. 3 depicts a simplified flow chart 300 of a method for performing facial animation according to one embodiment of the present invention. Step 302 determines the image as discussed above.

Step 304 detects a facial region in the image. For example, a number of points for features in the facial region are determined.

Step 306 normalizes the face. The facial region is standardized into a form based on the facial feature information and the content that the facial region will be inserted into.

Step 308 then animates the facial region into a series of expressions. These expressions may be the ones that may be inserted into the content.

Step 310 plays the content with the animated facial expressions. The animated facial expressions may be embedded in the content in a region where a face was previously found.

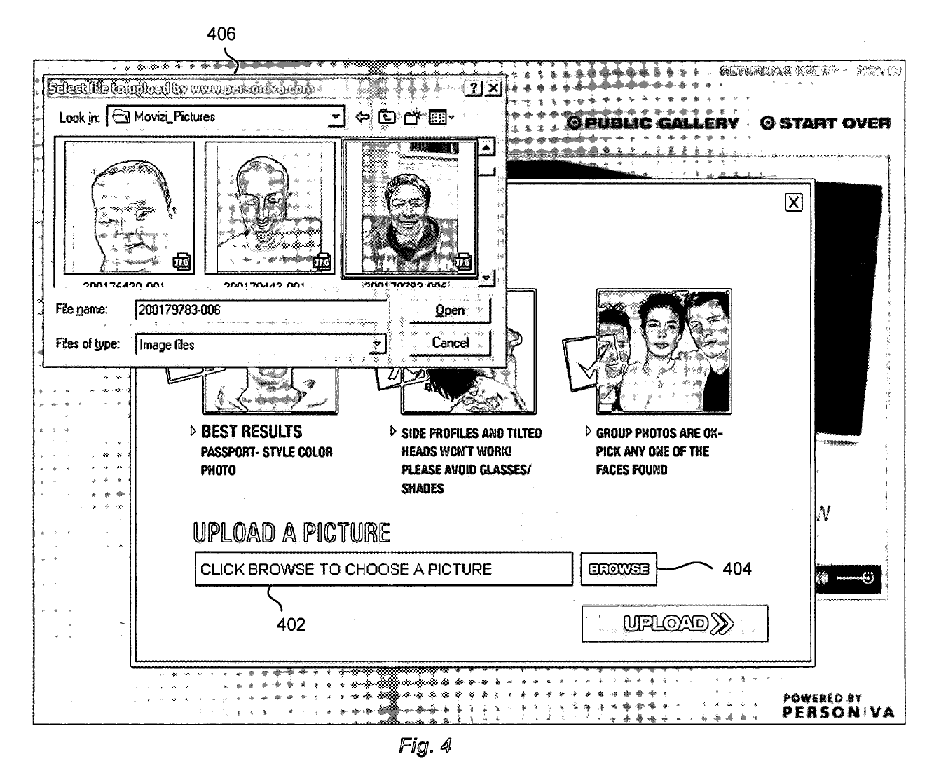

FIG. 4 depicts an example for determining an image according to one embodiment of the present invention. A user may navigate to a webpage that allows uploading of an image. As shown, an entry box 402 is provided to allow the uploading of an image. In one embodiment, a browse button 404 may be selected that may open a window 406. Window 406 may be used to pick an image to upload. As shown, a picture “Pic 1 jpeg” has been selected. This image includes an image of a user.

Once the picture is uploaded, the steps described above may be performed to determine the facial image and also to animate the facial image.

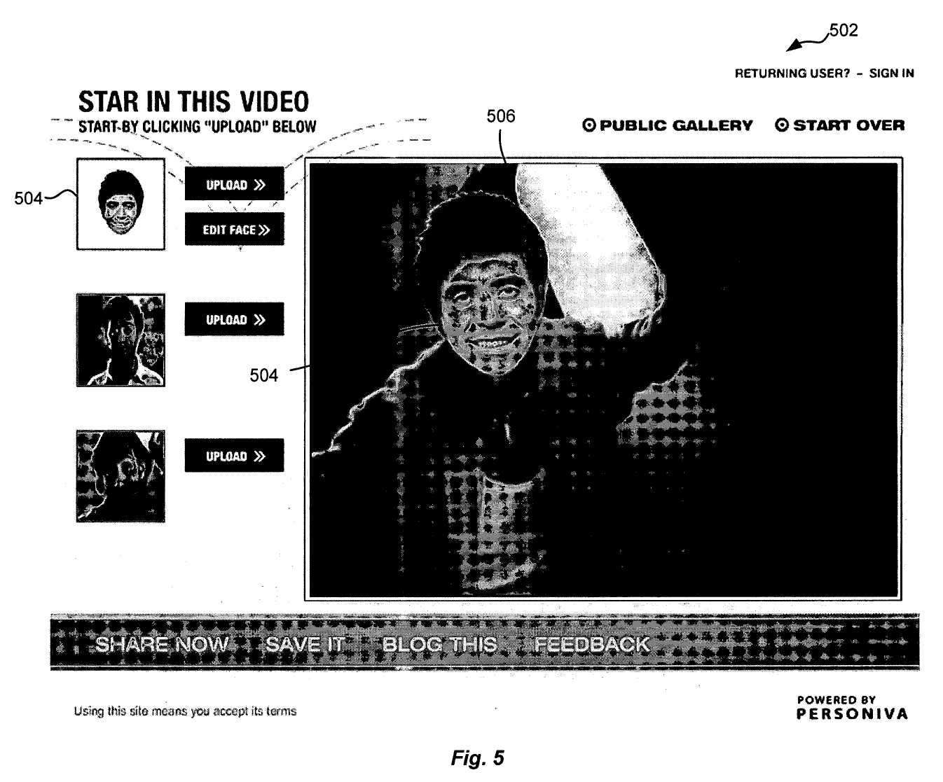

FIG. 5 shows an example of an animated facial image that has been inserted in content according to one embodiment of the present invention. As shown in a player 502, an image of a user's face 504 has been inserted in the content. Player 502 may be any application capable of playing the content, such as a media player, plug-in, DVD application, etc.

In one embodiment, one expression that has been generated for facial image 504 is shown. This facial expression is inserted in the content at a position where the person's face used to be. Additionally, hair 506 may be inserted with the facial image. FIG. 5 shows a frame in the content. Different facial expressions may be inserted for each frame of the content. This provides facial animation for the entire piece of content.

As shown, a piece of digital content may be provided with a user's face in place of the face of the original person in the commercial. Once the user uploads his/her picture in FIG. 4, the process automatically generates the facial expressions and inserts them in the content without any other user intervention. Accordingly, multiple users may use the process to upload their own pictures of a user. The faces of the users may then be automatically inserted into the commercial and animated.

When providing a web site, being able to dynamically personalize content is useful. The number of steps that a user is required to perform should also be minimized. In this case, the user just has to upload his/her image. In other embodiments, the user may not even have to upload the image. Rather, the user may be identified through a user identifier, such as a cookie, and then a picture is retrieved. The animation is then performed and provided to a user through a web browser automatically after determining the image to use. This can provide on demand personalized content to a user.

As discussed above, embodiments of the present invention may be used in many different applications. For example, some of the applications include a virtual store where a user's image may be inserted into an advertisement. In one example, the user's facial image may be inserted into a web page animation. Also, the facial animation may be used on cellular telephone and instant messaging. For example, avatars, emoticons, images of the users, etc. may be used in instant messaging or on a cellular phone. Also, wallpapers, banner ads, billboards, etc. may also use the facial animation. Further, when watching TV, a user's image may be inserted in commercials that are being played. Also, personalized DVDs and video-on-demand may be provided.

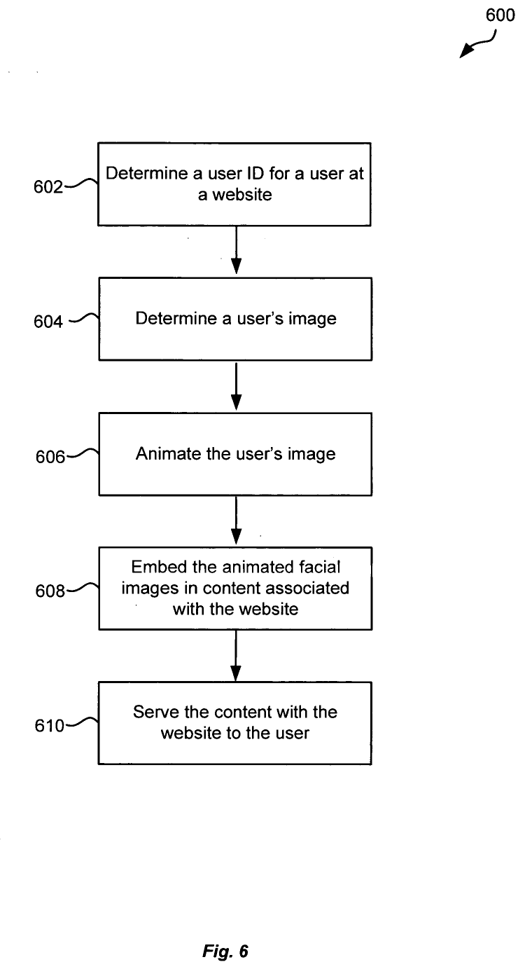

FIG. 6 depicts a method of an example for an application provided on a web site according to one embodiment of the present invention. Although a website is discussed, the application may be provided in any medium, such as through a mobile phone, television, etc. Step 602 determines a user ID for a user at a website. In this case, the user may be browsing the Internet and downloads a webpage for a website. The user ID may be determined by any methods, such as using cookies, using log-in information, etc.

Once a user ID is determined, step 604 determines a user's image. For example, step 604 may take the user ID and determine which user is associated with the user ID. An image of the user may be stored on server 102, or any other place. For example, the image may be stored in a remote location, such as in a server farm, etc. This image is then retrieved.

Step 606 then animates the user's image as described above. Step 608 then embeds the animated facial images in content associated with the website. For example, the website may include a banner ad, video, commercial, etc. The user's animated facial images are then inserted into this content.

Step 610 then serves the content to the user in the website. In this case, the user may view the content on display device 104. The content includes the user's animated facial image. Accordingly, the user may browse the web and when the website is downloaded, the user may be presented with personalized content. This may be done automatically without any user intervention. All that is needed is to identify the user and then the user's image may be determined from any location.

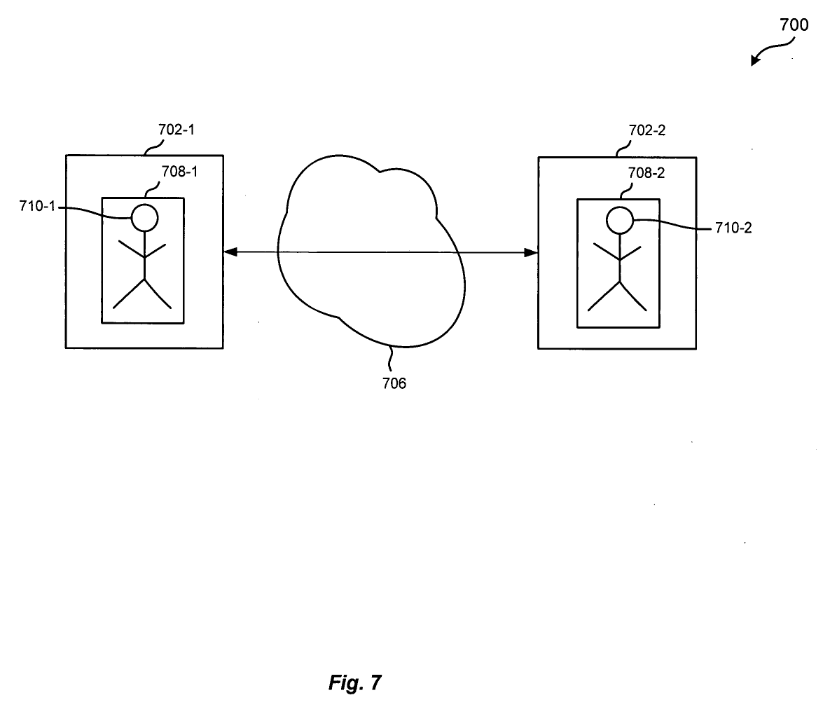

Other applications may also be personalized. For example, FIG. 7 depicts a system 700 for providing a personalized conversation according to one embodiment. As shown, a first telephone device 702-1 and a second telephone device 702-2 are provided. These telephone devices 702 communicate through a network 706.

In one embodiment, telephone devices 702 may be VoIP-enabled devices. Network 706 may be any network, such as a packet-based network, the Internet, a wireless network, a wire line network, a private network, etc.

Telephone devices 702 include displays 708. These may be used to display video of a user. For example, telephone device 702-1 may display content of a user who is using telephone device 702-2 and vice versa.

The content shown may include an image of a user in addition to a facial image 710. Facial image 710 may be animated using embodiments of the present invention. For example, facial image 710 may change expression during the conversation. In one embodiment, the expression may change based on the conversation. For example, if particular embodiments detect that a user may be angry, such as through the voice (e.g. tone, pitch, etc.) or through detection of various facial features, an expression in facial image 710 may be changed to an angry expression. Facial recognition techniques may be used to detect an expression on the face. Then, the expression is changed in facial image 710 to be that expression.

When a conversation is started, telephone device 702 may detect which user is using telephone device 702-2. In one embodiment, telephone 702-2 may send an image of a user to telephone device 702-1. Telephone device 702-1 may then determine the facial region and then animate the face according to embodiments of the present invention. This is done automatically when the image of the user is determined. This process may also be repeated with respect to telephone device 702-2.

Accordingly, embodiments of the present invention provide many advantages. For example, images of non-standard faces may be used to dynamically generate content that includes the face found in the images. Many pictures can be taken and faces extracted from the pictures. These faces may be automatically embedded in content and animated in a standard way.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method for facial animation for content, the method comprising:
determining an image of a user;
detecting facial feature information for a facial region in the image;
normalizing the facial region based on the content and the information for the facial region; and
automatically animating the normalized facial region into a series of animated facial images such that the series of animated facial images can be automatically inserted in the content in place of another facial region in the content.

2. The method of claim 1, wherein determining the image comprises receiving an uploaded image from a user device.

3. The method of claim 1, wherein determining the image comprises determining the image from a search of web pages, a scan of a document, a uniform resource locator (URL), video, or an uploaded picture.

4. The method of claim 1, wherein detecting facial feature information for comprises detecting a plurality of points on the facial region indicating facial features of a face.

5. The method of claim 4, wherein normalizing the facial region comprises standardizing the facial region using the plurality of points to generate a standard sized image.

6. The method of claim 5, wherein the normalizing standardizes the image to a form that is usable to generate the series of animated facial images for insertion in the content.

7. The method of claim 1, wherein animating the normalized facial region into a series of animated facial images comprises:
determining one or more pixels to modify to create an animated facial image; and
modifying the one or more pixels to create the animated facial image for insertion in the content.

8. The method of claim 1, further comprising:
inserting each of the series of animated facial images in the content; and
playing the content with the series of animated facial images to create content that includes the animated facial images in place of a second facial region in the content.

9. The method of claim 1, wherein determining the image of the user comprises receiving the image through a website, wherein the detecting, normalizing, and animating are performed automatically without any other user intervention.

10. The method of claim 1, wherein automatically animating comprises automatically animating the normalized facial region based on information determined for a conversation occurring for the user.

11. The method of claim 1, wherein the normalized facial region is an image of a face different from a second face found originally in the content.

12. A user interface configured to provide facial animation, the user interface comprising:
an uploader configured to allow uploading of an image of a user; and
a media player configured to, in response to the uploading of the image, automatically play content including a series of animated facial images inserted in the content in place of a first facial region in the content, wherein the series of animated facial images is automatically detected from the image facial feature information for a second facial region in the image.

13. The user interface of claim 12, wherein the user interface is included in a website.

14. The user interface of claim 13, wherein the image is uploaded through the website.

15. The user interface of claim 12, wherein the animated facial images are normalized based on the content in which the animated facial images are inserted into.

16. The user interface of claim 12, wherein the second facial region is automatically detected based on facial feature information.

17. The user interface of claim 12, wherein the content is automatically played including a series of animated facial images inserted in the content in place of a first facial region in the content without any user intervention after the uploading of the image.

18. An apparatus configured to provide facial animation for content, the apparatus comprising:
one or more processors; and
logic encoded in one or more tangible media for execution by the one or more processors and when executed operable to:
determine an image of a user;
detect facial feature information for a facial region in the image;
normalize the facial region based on the content and the information for the facial region; and
automatically animate the normalized facial region into a series of animated facial images such that the series of animated facial images can be automatically inserted in the content in place of another facial region in the content.

19. The apparatus of claim 18, wherein the logic when executed operable to determine the image comprises receiving an uploaded image from a user device.

20. The apparatus of claim 18, wherein the logic when executed operable to determine the image comprises determining the image from a search of web pages, a scan of a document, a uniform resource locator (URL), video, or an uploaded picture.
